(19) United States
(12) Patent Application Publication
(10) Pub. No.: US 2009/0219121 A1
(43) Pub. Date: Sep. 3, 2009

(54) SUPERCONDUCTING MAGNET CURRENT ADJUSTMENT BY FLUX PUMPING

(76) Inventors: Andrew Farquhar Atkins, West Sussex (GB); Michael John Disney Mallet, Lower Hutt (NZ)

Correspondence Address: SCHIFF HARDIN, LLP;PATENT DEPARTMENT, 6600 SEARS TOWER, CHICAGO, IL, 60606-6473, US

(21) Appl. No.: 12/392,132

(22) Filed: Feb. 25, 2009

(30) Foreign Application Priority Data
Feb. 25, 2008 (GB) 0803356.5

(51) Int. Cl. H01F 6/06

(52) U.S. Cl. 335/216

(57) ABSTRACT

In a superconducting magnet arrangement having main magnet windings, a first switch is connected between first and second ends of the main magnet windings, an induction coil has a first end connected to the first end of the main magnet windings and having a second end connected through a second switch to the second end of the main magnet windings, and a further coil capable of magnetically coupling with the induction coil, current flowing in the main magnet windings is adjusted by flux pumping.

### BACKGROUND OF THE INVENTION

1. Field of the Invention

The present invention relates to methods and equipment for adjusting current flowing in superconducting magnets. The invention is particularly applicable to superconducting magnets employed in imaging systems such as magnetic resonance imaging (MRI) systems.

2. Description of the Prior Art

Once a superconducting magnet is installed ready for use, it must be energized. Electrical current must be introduced into the coil windings. A superconducting switch is usually provided across the coil windings. When this switch is superconducting, a closed superconducting current path is provided through the coil windings. Once the current has been established in the coil windings, the current will continue to flow with only gradual reduction in current magnitude. A superconducting magnet is typically energized (‘ramped’) by connecting a low voltage, high current power supply across the superconducting switch at suitable input terminals. The superconducting switch is temporarily held in a non-superconducting state to allow current to be introduced into the magnet windings. Present MRI magnets typically carry currents of about 400-500 A. This method of energization requires a suitable power supply to be available when the procedure is due to occur.

Although electrical current flows substantially unimpeded in the superconducting magnet, the magnitude of the current flowing will gradually diminish due to imperfections such as non-zero resistance in wire joints. At regular intervals after the initial energization, typically once per year in present systems, further electrical current will need to be supplied into the magnet to restore the current to its initial value. Typically, this current re-establishment is achieved by reconnecting the low voltage, high current power supply across the superconducting switch, temporarily placing the superconducting switch in a non-superconducting state, for example, by applying heat to the superconducting switch, and increasing the current into the magnet by a process very similar to the original energization. This operation is colloquially known as ‘bumping’ the magnet back to its initial field value. Such operation requires reconnection of the power supply and appropriate operation of the superconducting switch. Usually, a service technician is sent to the site of the magnet to perform these operations.

It would be beneficial if such current re-establishment (‘bumping’) could be carried out without the need to reattach the power supply; and/or without the need for a service technician to attend.

### SUMMARY OF THE INVENTION

The present invention provides methods and apparatus for current re-establishment in superconducting magnets, and removes the need for an external power supply to provide a current source for the current re-establishment (‘bump’) procedure. According to an embodiment of the present invention, a gradient winding and gradient winding power supply, typically conventionally provided in any superconducting magnet-based imaging system, are used to ‘bump’ the magnet.

The present invention encompasses a superconducting magnet arrangement and a method for adjusting a current flowing in the main or basic field magnet windings of a superconducting magnet arrangement, wherein the basic field magnetic windings have a first switch connected between first and second ends of the basic field magnet windings, the first switch being controllable between two states, of which a first state is relatively conductive and a second state is relatively non-conductive, and induction coil having a first end connected to the first end of the basic field magnet windings and a second end connected through a second switch, with the second switch being controllable between two states, a first of which is relative conductive and a second of which is relative non-conductive, and the second switch being connected to the second end of the basic field magnet windings, and a gradient coil that is capable of magnetically coupling with the induction coil.

In accordance with the present invention, the second switch is controlled into its second state so as to change the magnitude and/or direction of a current flowing in the gradient windings, thereby producing a change in the magnitude and/or direction of magnetic flux that couples with the induction coil. Additionally, the first and second switches are controlled into their first conductive states so as to change the magnitude and/or direction of the current through the gradient windings, so as to induce a current in the gradient coil, which serves to maintain a residual magnetic flux in the induction coil. Additionally, the first switch is controlled into its second state such that the induced current flows through both the induction coil and the basic field magnet windings, to maintain the residual magnetic flux within both the induction coil and the basic field magnet windings.

The first switch also is controlled into its first state and the second switch is controlled into its second state, so as to leave a changed level of current flowing in the basic field magnet windings.

### DESCRIPTION OF THE DRAWINGS

FIG. 1 schematically shows an axial half-cross section of coils in a superconducting magnet.

FIG. 2 illustrates an example of conventional actively shielded gradient winding interconnection in a magnet arrangement including an induction coil according to an aspect of the present invention.

FIG. 3 shows an implementation of the present invention, where a switching arrangement is used to cause current flowing in each gradient shield winding to flow in the same direction as the current flowing in the corresponding gradient winding.

FIG. 4 shows an idealized circuit diagram of a magnet and gradient winding flux pumping arrangement according to the present invention.

FIGS. 5A-5I show stages in a method according to an embodiment of the present invention.

### DESCRIPTION OF THE PREFERRED EMBODIMENTS

The present invention provides methods and apparatus for ‘bumping’ a superconducting magnet without the need for an external power supply for the purpose. In addition, certain embodiments of the invention allow remote ‘bumping’ simply by controlling parts of the installed magnet system. The remote ‘bumping’ may be initiated by telephone or over the internet. Alternatively, a simple user-operated control may be provided to initiate ‘bumping’. Alternatively, a regular ‘bumping’ cycle may be set to operate at fixed time intervals. Alternatively, a ‘bumping’ cycle may be initiated in response to a measurement indicating a certain level of current degradation in the magnet coils.

The various embodiments of the present invention provide at least some of the following advantages:

reduced service cost due to reduced equipment requirement, as no magnet power supply is required for ‘bumping’;
magnet ‘bumping’ is performed by equipment already available on site, typically gradient windings and gradient power amplifier; and
reduced requirement for site visits by maintenance technicians, due to the possibility of remotely- or automatically-controlled ‘bumping’; or user-initiated ‘bumping’.

The present invention achieves current re-establishment (‘bumping’) by use of a magnetic flux pump. While it is believed that a magnetic flux pump will be familiar to those skilled in the art, a brief description of the operation of a flux pump is provided here for reference.

Magnetic flux pumping is a method for varying a current in a superconducting circuit by changing the magnetic flux within the superconducting circuit using a sequence of steps of applying and removing external flux. Such operation can be explained by writing Faraday's law of induction for a closed circuit of resistance, R, and inductance, L.

$$\begin{matrix}\frac{d φ}{d t} = - V \\ = - RI - \frac{d LI}{d t}\end{matrix}$$

A superconducting circuit has zero resistance, so setting R=0 and integrating gives:

φ+LI=k

where k is a constant representing the total flux in the circuit. In words, the total of the flux LI produced by current flowing in the circuit and any externally applied flux φ is constant. Flux pumping, described below in its specific application to the present invention, enables the constant k to be changed, so changing the current I flowing in the superconducting magnet of inductance L. This equation demonstrates that a superconducting circuit reacts to any change in external flux, φ, by an opposing change in the current, I, in order to maintain a constant value of k.

According to an embodiment of the present invention, an external source of magnetic flux φ is provided by causing a change in magnitude and/or direction of an electric current in an existing gradient winding within a superconducting magnet-based imaging system using a corresponding gradient power amplifier.

Simply causing a change in current through a gradient winding circuit will not be sufficient to induce current re-establishment (‘bumping’) in a typical superconducting magnet-based imaging system, due to the symmetry of typical systems. An increase in externally applied flux φ at one end of the magnet would be balanced by an equal decrease in externally applied flux φ at the other end of the magnet, resulting in no overall change of the current through the magnet.

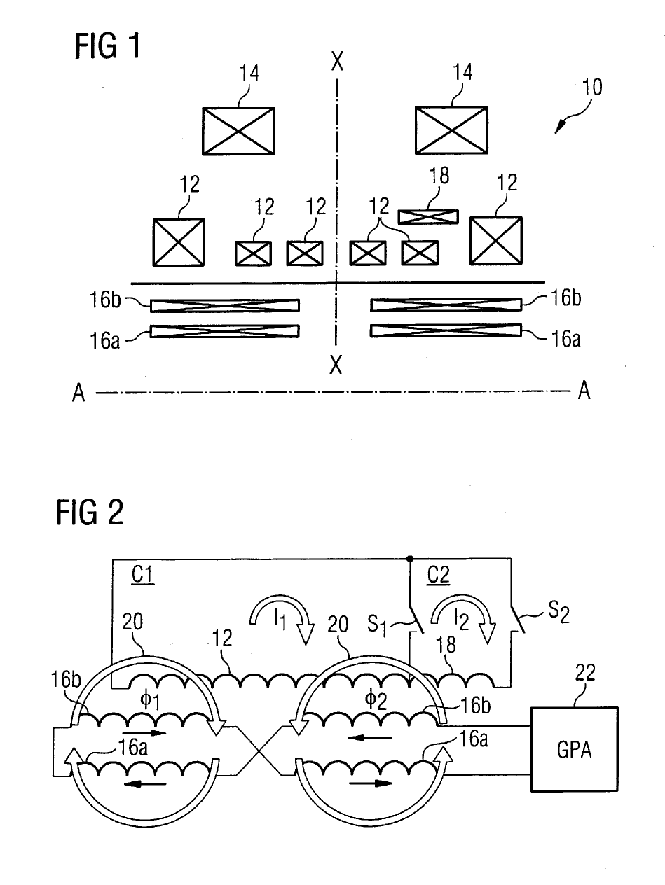

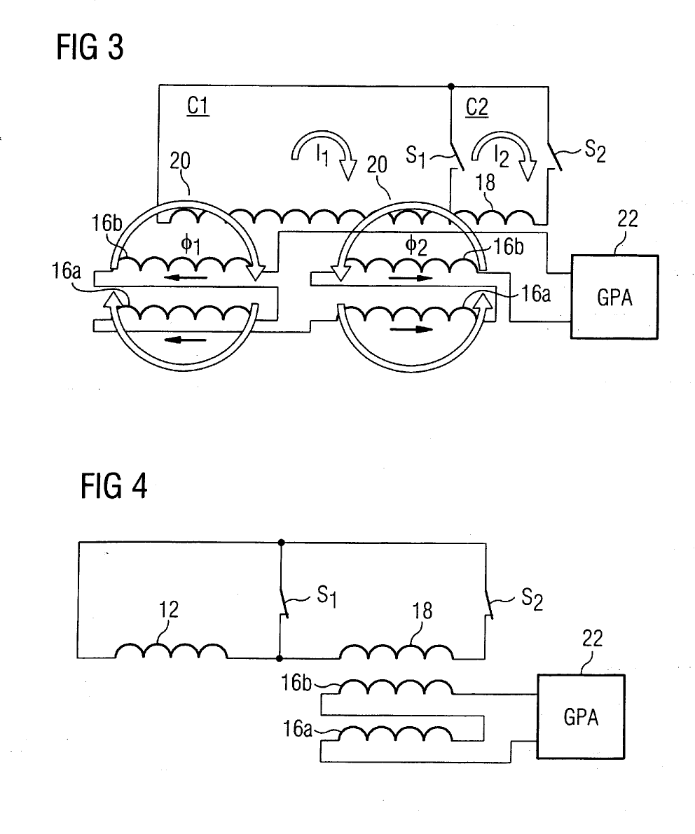

According to an aspect of the present invention, a separate superconducting coil is connected to the main magnet circuit. FIG. 1 schematically illustrates possible arrangements of coils in a superconducting magnet 10. FIG. 1 represents an axial half-cross section symmetrical about axis A-A, with a nominal plane of symmetry X-X. Conventionally, the axial direction is referred to as the Z-direction, a vertical radial direction is referred to as the X-direction, and a radial direction perpendicular to the X-direction is referred to as the Y-direction. The coils include primary magnet coils 12 which generate the main magnet field; shield coils 14 which reduce the stray magnetic field outside of the coil arrangement; a gradient winding having gradient windings 16a generates magnetic field gradients as required for imaging; a gradient shield winding comprising gradient shield windings 16b reduces the stray magnetic field outside of the gradient winding; and an induction coil 18, according to an aspect of the present invention. The induction coil 18 is asymmetrically installed into the magnet coil arrangement so that the field generated by each gradient winding 16a and gradient shield winding 16b does not cancel itself out in the induction coil 18. Induction coil 18 is not connected in series with the main magnet windings, but is connected to them, as illustrated in FIG. 2.

Typically, in use, gradient windings 16a, 16b towards one axial end of the magnet provide increased magnetic flux density, while gradient windings 16a, 16b towards the other axial end of the magnet provide reduced magnetic flux density, in order to provide the required magnetic field gradient for imaging. By placing the induction coil 18 near one end, and generating an increased magnetic flux density by the adjacent gradient windings 16a, 16b, the required flux pumping for current re-establishment (‘bumping’) may be achieved, as described below.

In normal operation, the gradient windings 16a, and gradient shield windings 16b are connected such that a magnetic gradient can be created in the X, Y & Z directions. This is normally achieved by having an actively shielded Maxwell pair of coils in the Z axis and two orthogonal sets of Golay pairs in the X & Y axes. The gradient windings 16a shown in FIG. 1 are the Z gradient windings and gradient shield windings 16b are the corresponding shield windings. Each gradient shield winding 16b produces a magnetic field of reduced flux density and opposite polarity to that of the accompanying gradient winding 16a. The gradient shield windings 16b typically reduce the magnetic flux density generated by the gradient windings 16a that crosses the main magnet circuit 12, so reducing the interaction between the primary magnet coils 12 and the gradient windings 16a.

The inductance of the induction coil 18 may, for example, be of several tens of millihenry. Present MRI magnets typically have a main coil comprising main magnet windings 12 of total inductance of several henries.

FIG. 2 illustrates an example of conventional actively shielded gradient winding interconnection in a magnet arrangement including an induction coil 18 according to an aspect of the present invention. The switch S1 is part of magnet circuit C1 and is a superconducting switch with a normally open state and a superconducting ‘closed’ state. The switch S2 is part of induction circuit C2 and may be a non-superconducting switch with a normal high impedance ‘open’ state and a normal low impedance ‘closed’ state. The switch S2 may be a solid state device and may be located within a cryostat containing the superconducting magnet coils 12 at a higher temperature location within the cryostat, e.g. within the turret, to allow the switch to function correctly. Alternatively, the switch S2 may be a superconducting switch, similar to switch S1. During bumping, current I₂ will flow through the induction coil 18, while the main magnet circuit C1 experiences only small changes in the total magnet current I₁.

As shown, the current in each gradient winding 16a is provided by gradient power amplifier GPA 22, and flows in the opposite direction from the current in the accompanying gradient shield winding 16b. This results in a limited magnetic coupling 20 between the gradient winding 16a and the main magnet windings 12, and between the gradient winding 16a and the induction coil 18. In normal magnet operation, a low level of magnetic coupling 20 is preferred, to avoid any interference with the main magnetic field. However, for the purposes of the present invention, a high level of magnetic coupling 20 between the gradient windings 16a, and the gradient shield windings 16b; and the induction coil 18 would be preferred.

One or more switches S2 are included in the induction circuit C2 to provide multiple current paths within the induction coil/magnet circuit. This allows current to be accumulated in the magnet circuit by flux pumping.

According to certain embodiments of the present invention, a switching arrangement is provided to allow current in the gradient winding 16a and gradient shield winding 16b to be redirected between the separate gradient windings and gradient shield windings to allow increased magnetic coupling 20 between the induction coil 18 and the gradient windings 16a, and gradient shield windings 16b. This causes more external magnetic flux φ to cross the induction coil circuit C2, which can be used for flux pumping.

To increase the external magnetic flux φ from the gradient windings 16a, and gradient shield windings 16b that is experienced by the induction coil 18, the gradient windings 16a and gradient shield windings 16b may have an additional switch arrangement to either cancel the behavior of the gradient shield windings 16b or to reverse the current direction in the gradient shield windings, so reinforcing the flux from the gradient windings 16a. Such switch arrangement may be provided by any suitable switching device, such as a mechanical switch or solid state device.

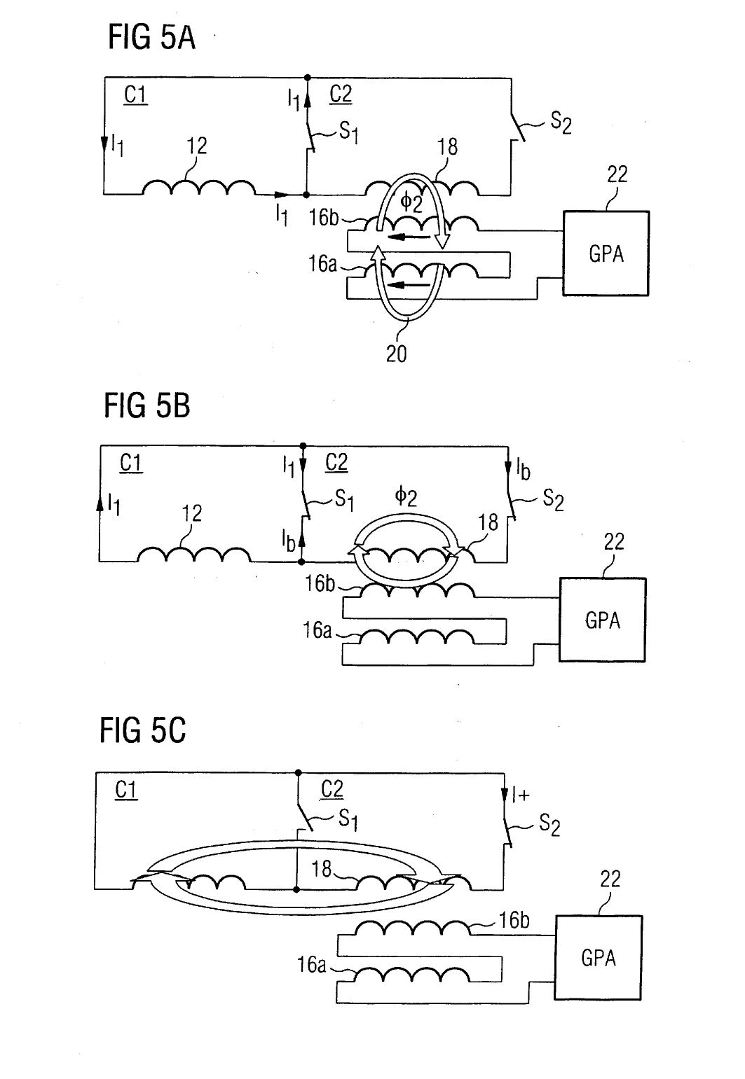

FIG. 3 shows such an implementation, where a switching arrangement is being used to cause current flowing in each gradient shield winding 16b to flow in the same direction as the current flowing in the corresponding gradient winding 16a. A greater level of magnetic coupling 20 is achieved than in the case of FIG. 2. This causes an increased change in external magnetic flux φ1, φ2 to be produced at each end of the magnet axis as a result of current flowing in the gradient windings 16a and the gradient shield windings 16b. However, due to the symmetry of the main magnet windings 12 and the gradient windings 16, no overall change in current occurs in the main magnet windings 12. On the other hand, as the induction coil 18 is asymmetrically placed, a significant change in externally applied magnetic flux φ2 crossing the induction coil 18 is observed. This change in flux may be translated into a change in the current I₂ in the induction coil 18, which may in turn be employed by the present invention to adjust the current I₁ in the magnet circuit C1 as will be discussed in detail below.

A flux pumping procedure can then be applied to the magnet by use of the described switching arrangements to allow external magnetic flux φ from the gradient windings 16a and gradient shield windings 16b to be accumulated as current I₂ within the induction coil 18 and then transferred to the magnet circuit C1.

According to an embodiment, the apparatus of the present invention comprises a superconducting solenoidal magnet 10 with a coaxially located gradient coil 16a, and gradient shield coil 16b; an associated gradient power amplifier 22 and an asymmetrically positioned induction coil 18, with switches S1 and S2 controlling current flow in the main magnet windings 12 and the induction coil 18.

The superconducting magnet 10 is provided with a switching arrangement such as switches S1 and S2 to redirect current induced during flux pumping of the induction coil 18 by the gradient windings 16a and gradient shield windings 16b, so as to allow current induced in the induction coil 18 to be accumulated within the main magnet windings 12.

Both of the switches S1 and S2 and the induction coil 18 must be capable of taking the full magnet current I₁.

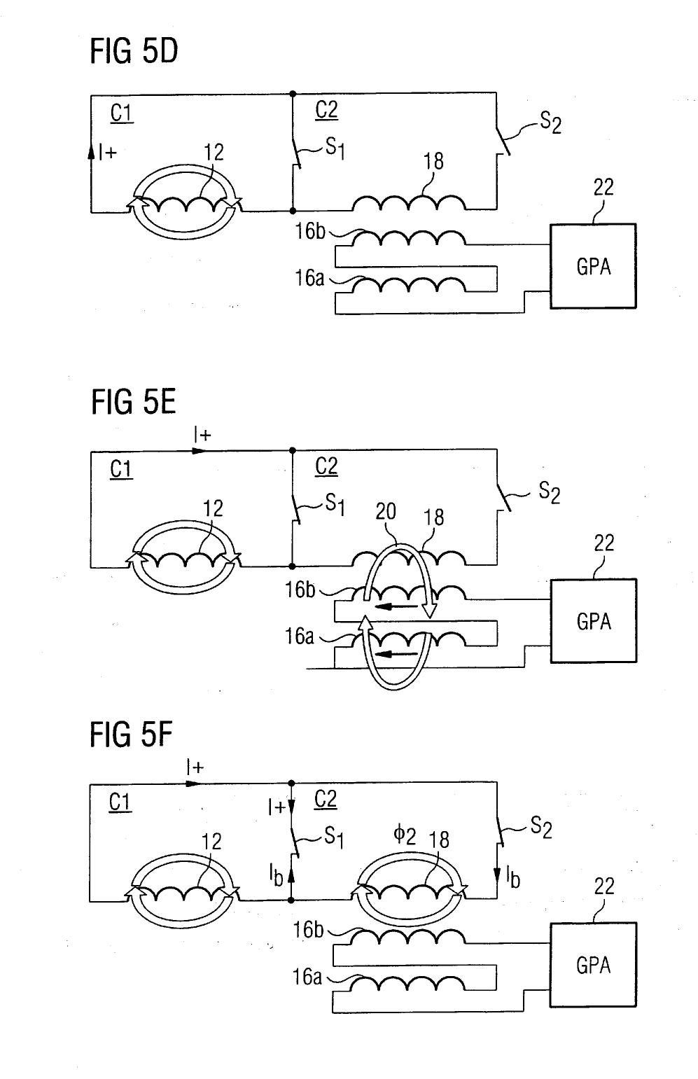

FIG. 4 shows an idealized circuit diagram of a magnet and gradient coil flux pumping arrangement according to the present invention. Gradient winding 16a and gradient shield winding 16b are connected so as to generate magnetic fields in a same direction. Switches S1 and S2 are shown closed. The gradient winding 16a and the gradient shield winding 16b will, for simplicity of the following description of the principle of the invention, be taken to couple only with the induction coil 18 and not with the main magnet windings 12. This will of course not be the physical reality, but the gradient coil will couple more strongly with the induction coil than the main magnet winding due to the asymmetrical positioning of the induction coil. The switching arrangement provided for the gradient windings may be used to disconnect gradient windings at one end of the magnet, ensuring that only those gradient windings with best coupling to the induction coil 18 are used, as shown in FIG. 4.

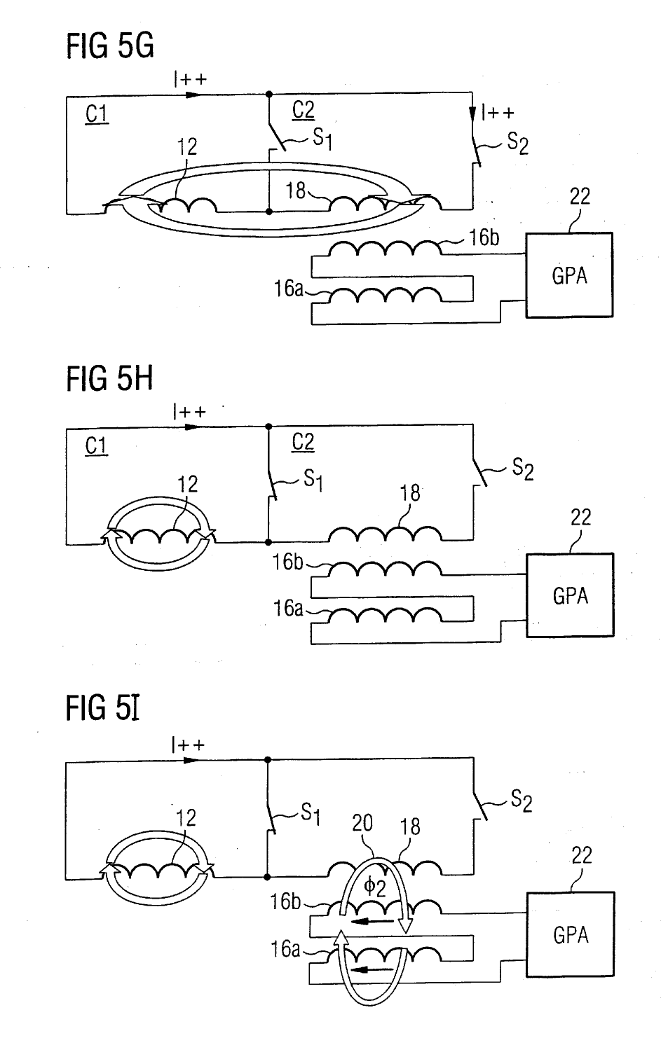

Operation of the flux pumping sequence according to an embodiment of the present invention will now be described with reference to FIGS. 5A-5I. In the following description, L₁₂ and L₁₈ are inductances of the main magnet coils 12 and the induction coil 18 respectively, while k₁ represents the initial total flux in the main magnet coils 12.

Initially, as shown in FIG. 5A, switch S1 is closed, allowing an initial current I₁ to flow in circuit C1, through the main magnet windings 12. Switch S2 is open. Current is provided to gradient winding 16a and gradient shield winding 16b by gradient power amplifier 22. This current causes an externally applied flux φ of value φ2 to cross the induction coil 18 in open circuit C2.

In this arrangement, the current flowing in induction coil 18 is zero, so the total flux in induction coil 18 is φ2. Assuming that no externally applied flux crosses the main magnet coils, the total flux in the main magnet coils 12 is:

L₁₂·I₁=k₁.

In a next step, as illustrated in FIG. 5B, switch S1 remains closed while switch S2 is closed, completing circuit C2. The current through gradient winding 16a and gradient shield winding 16b provided by gradient power amplifier 22 is turned off. The externally applied flux φ falls to zero. This induces a current Ib in circuit C2 to preserve the flux φ2 in induction coil 18, such that:

L₁₈·I_{b}=φ2.

In a next step, as illustrated in FIG. 5C, switch S1 is opened while switch S2 remains closed. The total flux in the circuit comprising the main magnet coils 12 and the induction coil 18 is now L₁₂·I₁+φ2. An increased current I+ now flows through the induction coil 18 and the main magnet windings 12 to preserve the total flux such that:

(L₁₂+L₁₈)·I+=L₁₂·I₁+φ2.

The increase in current is approximately φ2/L₁₂.

In a next step, as illustrated in FIG. 5D, switch S1 is closed while switch S2 is opened. Current ceases to flow in induction coil 18, but increased current I+ now flows in circuit C1. The current flowing in main magnet windings 12 has been increased by approximately φ2/L₁₂ as compared to the situation in FIG. 5A. An increase in magnetic flux in the main magnet windings 12 is preserved in circuit C1 by increased current I+ flowing through main magnet windings 12; such that to a first approximation:

L₁₂·I+=k₁+φ2.

The current in the main magnet coils has evidently been increased by this flux pumping operation. Further flux pumping cycles may be performed as follows.

In a next step, as illustrated in FIG. 5E, switch S1 remains closed and switch S2 remains open, while current through gradient winding 16a and gradient shield winding 16b is again provided by gradient power amplifier 22. The current flowing in the gradient winding 16a and the gradient shield winding 16b again induces a magnetic flux φ2 in the induction coil 18 of circuit C2. As no current flows in induction coil 18, the total flux in induction coil 18 is again φ2.

In a next step, as illustrated in FIG. 5F, switch S1 remains closed while switch S2 is closed, completing circuit C2. The current through gradient winding 16a and gradient shield winding 16b provided by gradient power amplifier 22 is turned off. This induces a current Ib in circuit C2 to preserve the flux φ2 in induction coil 18, such that:

L₁₈·I_{b}=φ2.

In a next step, as illustrated in FIG. 5G, switch S1 is opened while switch S2 remains closed. The total flux in the circuit comprising the main magnet coils 12 and the induction coil 18 is now (L₁₂·I++φ2). A further increased current I++ now flows through the induction coil 18 and the main magnet windings 12 to preserve the total flux, such that:

(L₁₂+L₁₈)·I++=L₁₂·I++φ2.

In a next step, as illustrated in FIG. 5H, switch S1 is closed while switch S2 is opened. Current ceases to flow in induction coil 18, but further increased current I++ now flows in circuit C1. The current flowing in main magnet windings 12 has been changed by magnitude approximately φ2/L₁₂ as compared to the increased current I+ in FIG. 5D. The total magnetic flux is preserved in circuit C1 by current I++ flowing through main magnet windings 12; such that to a first approximation:

L₁₂·I++=k₁+2·φ2.

In a next step, as illustrated in FIG. 5I, switch S1 remains closed and switch S2 remains open, while current through gradient winding 16a and gradient shield winding 16b is again provided by gradient power amplifier 22. The current flowing in the gradient winding 16a and gradient shield winding 16b again induces a magnetic flux φ2 in the induction coil 18 of circuit C2.

The above sequence of steps may be repeated as required to further increase the current flowing in the main magnet windings 12 by a further amount approximately equal to φ2/L₁₂. A limit may be reached when the flux in main magnet windings 12 reaches about the same level (φ2) as that generated in the induction coil by the gradient winding 16a and gradient shield winding 16b when current is provided by the gradient power amplifier 22; that is, when the current in the main magnet coils reaches the value of φ2/L₁₈.

Depending on the circuit components used, each cycle of the described flux pumping may be completed in a few seconds.

Alternatively, by applying the current in the gradient winding 16a and the gradient shield winding 16b in the opposite direction, the current in the main magnet windings 12 may be progressively reduced in steps approximately equal to φ2/L₁₂, in a corresponding fashion.

As may be observed from considering the above description, it is not necessary to connect any special equipment to perform current re-establishment (‘bumping’). All that is required is to perform a certain sequence of switching of the connections of the gradient windings and gradient shield windings, the circuit switches S1 and S2 and switching on and off of the current through the gradient windings. Such operation may be readily automated by those skilled in the art, and arrangements may be made to have such current re-establishment performed at predetermined time intervals or in response to the detection of a reduced current in the main magnet windings 12, or in response to user initiation by operation of a simple control. It may be possible to arrange a superconducting magnet-based imaging system such that current re-establishment (‘bumping’) is performed before each imaging operation.

This invention encompasses a method by which the current in a superconducting magnet for an imaging system can be varied by using the associated gradient coil as flux pump. Apparatus for performing such current variation is also described.

In order to facilitate flux pumping by the gradient coil, a separate superconducting induction coil 18 is preferably provided, situated asymmetrically within the magnet coil arrangement. In a solenoidal magnet arrangement, the induction coil 18 is preferably coaxial with the other magnet coils but is offset axially to allow coupling between itself and the gradient windings 16a, 16b. It is envisaged that, within a solenoidal magnet, the induction coil 18 may be wound on a common former with the main magnet windings 12.

An induction coil switch S2 is wired in series with the induction coil 18. The switch S2 may be a superconducting switch and having a normal ‘open’ state and a superconducting ‘closed’ state. Alternatively, the induction coil switch S2 may be a solid state device located at a relatively warm location in the magnet arrangement, e.g. within a turret assembly of a cryostat housing the superconducting magnet. Induction coil switch S2 may also be any other type of controlled non-superconducting switch.

A switching arrangement controlling switches S1 and S2 allows the current in the superconducting magnet circuit C1 to be altered such that externally applied magnetic flux φ can be trapped within an associated coil 18 and the resulting reaction current Ib can be accumulated within the main magnet circuit C1.

A switching arrangement for the gradient windings and the gradient shield windings can be provided to allow the gradient coil current to be redirected in such a fashion that the magnetic flux coupling between the induction coil 18 and gradient windings 16a and the gradient shield windings 16b is increased. Typically, this is by causing gradient shield winding 16b to carry current in a same direction as an associated gradient winding 16a.

A gradient coil current pulsing scheme, achieved by control of a gradient power amplifier 22 connected to supply current to the gradient coil, is timed to interact with the switching of the controlled switches S1, S2 within the magnet arrangement to cause current to be accumulated or diminished within the main magnet windings 12, enabling current re-establishment (‘bumping’), or controlled reduction of current in the main magnet windings 12.

In addition to avoiding the need for a power supply to be provided for current re-establishment, the present invention also avoids the need to reconnect current leads to the magnet coils. Typically, current leads are connected to the current coils only when required for introducing or removing current, and are removed at other times to reduce heat influx.

Preferably, in order to provide improved efficiency of energy transfer, the time constant of the part of the gradient coil 16 used for flux pumping is adapted to match as closely as possible to that of the part of the induction coil 18 which is used for magnet energization.

The described current re-establishment (bumping may be usefully employed in order to set a desired initial magnet operating current at installation, and to restore the initial magnet operating current after decay events. Indeed, the invention could be used for the complete energization (ramping up) or de-energization (ramping down) process of a superconducting magnet. Field decay during normal magnet operation may preferably be compensated for by an automated ‘bumping’ process as described. In addition, high decay magnets presently considered unfit for use could be accepted, if the present invention is employed, since bumping can occur on a regular basis, such as daily or even more frequently if required.

As is well known, it is simpler to make non-superconducting joints than superconducting joints, for example by simply soldering superconducting wires together. Such non-superconducting joints have hitherto been considered unacceptable, due to the resulting current degradation. The invention allows the possibility of using non-superconducting joints within the magnet circuit, since the current degradation caused by non-superconducting joints may be readily compensated by the current reestablishment method of the present invention. Such method may be applied to magnets of any strength, and current degradation may be compensated by the methods according to the present invention. Hence, manufacturing costs of superconducting magnets may be reduced.

The invention should be equally applicable to both low temperature and high temperature superconducting magnets.

The present invention has been described with reference to gradient windings and gradient shield windings operating to provide the flux for flux pumping. The use of gradient windings and gradient shield windings is preferred, partly because the associated gradient power supplies 22 are capable of delivering currents of the same order of magnitude as those flowing in the main magnet windings 12. On the other hand, it is not presently considered practical to use any of the magnet coils themselves in the place of the described gradient windings and gradient shield windings for flux pumping, as the resultant forces are considered excessive. In embodiments which use gradient windings for flux pumping, the gradient shield windings may be simply turned off by a switching arrangement, rather than used in support of the gradient windings.

While the present invention has been particularly described with reference to solenoidal magnets, the present invention may be applied to other magnet arrangements, such as open, biplanar, disc or asymmetric magnets, as will be apparent to those skilled in the art.

In magnets which employ active shield coils 14, these are typically connected in series with the main magnet windings 12 in the magnet circuit C1, although active shield coils 14, are not mentioned in the description of FIGS. 2-5I of the present application, for the sake of simplicity of description.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of adjusting a current flowing in main magnet windings of a superconducting magnet arrangement comprising: main magnet windings having a first switching means connected between first and second ends of the main magnet windings, said first switching means being controllable between two states, a first state being relatively conductive and a second state being relatively non-conductive; an induction coil having a first end connected to the first end of the main magnet windings and having a second end connected through a second switch means, said second switch being controllable between two states, a first state being relatively conductive and a second state being relatively non-conductive, said second switch being connected to the second end of the main magnet windings; and a gradient coil capable of magnetically coupling with the induction coil and connected to a power supply, said method comprising the steps of:
(a) controlling the second switch to its second, relatively non-conducting, state and changing the magnitude and/or direction of a current flowing in the gradient windings to produce a change in the magnitude and/or direction of magnetic flux that couples with the induction coil;
(b) controlling first and second switches into their first, relatively conductive, states and changing the magnitude and/or direction of the current through the gradient windings to induce a current in the induction coil, which serves to maintain a residual magnetic flux in the induction coil;
(c) controlling the first switch into its second, relatively non-conductive, state such that the induced current flows through both the induction coil and the main magnet windings to maintain the residual magnetic flux within both the induction coil and the main magnet windings;
(d) controlling the first switch into its first, relatively conductive, state and controlling the second switch into its second, relatively non-conductive, state to leave a changed level of current flowing in the main magnet windings.

2. A method according to claim 1, further comprising repeating steps to further change the level of current flowing in the main magnet windings.

3. A method according to claim 1 comprising, with wherein a switching arrangement, enabling the connections of the gradient windings to be changed to cause selected gradient windings to carry no current, and/or to carry current in the opposite direction to a current carried for the purpose of generating gradient magnetic fields.

4. A method as claimed in claim 1 comprising placing said induction coil asymmetrically in a symmetrical solenoidal superconducting structure to increase the magnetic coupling with at least some of the gradient windings.

5. A method according to claim 1, comprising said method initiated by a remotely-initiated command signal received at the superconducting magnet arrangement by telephone, or over the internet.

6. A method according to claim 1, comprising initiating said method by a command initiated locally by a user-operated control.

7. A method according to claim 1, comprising initiating said method in response to detection of current in the main magnet windings having diminished below a certain threshold.

8. A method according to claim 1, comprising initiating said method in response to elapse a certain predetermined length of time since a previous implementation of the method.

9. A superconducting magnet arrangement comprising:
superconducting main magnet windings having a first switch connected between first and second ends of the main magnet windings, said first switching means being controllable between two states, a first state being relatively conductive and a second state being relatively non-conductive;
an induction coil having a first end connected to the first end of the main magnet windings and having a second end connected through a second switch to the second end of the main magnet windings, said second switch being controllable between two states, a first state being relatively conductive and a second state being relatively non-conductive;
gradient windings capable of magnetically coupling with the induction coil; and
a current source that provide a current to the gradient windings.

10. A superconducting magnet arrangement as claimed in claim 9 comprising a control unit configured to operate said first and second switches and said current source by:
(a) controlling the second switch to its second, relatively non-conducting, state and changing the magnitude and/or direction of a current flowing in the gradient windings to produce a change in the magnitude and/or direction of magnetic flux that couples with the induction coil;
(b) controlling first and second switches into their first, relatively conductive, states and changing the magnitude and/or direction of the current through the gradient windings to induce a current in the induction coil, which serves to maintain a residual magnetic flux in the induction coil;
(c) controlling the first switch into its second, relatively non-conductive, state such that the induced current flows through both the induction coil and the main magnet windings to maintain the residual magnetic flux within both the induction coil and the main magnet windings;
(d) controlling the first switch into its first, relatively conductive, state and controlling the second switch into its second, relatively non-conductive, state to leave a changed level of current flowing in the main magnet windings.

11. A super conducting magnet arrangement as claimed in claim 10 wherein said control unit is configured to repeat steps (a)-(d) to further change the level of current flowing in the main magnet windings.

12. A superconducting magnet arrangement according to claim 9 comprising a switching arrangement that enables connections of the gradient windings to be changed, to cause selected gradient windings carry no current, and/or to carry current in an opposite direction to a current carried for the purpose of generating gradient magnetic fields.

13. A superconducting magnet arrangement according to claims 9, being a symmetrical, solenoidal superconducting structure, wherein the induction coil is placed asymmetrically and has increased magnetic coupling with certain of the gradient windings as compared to its magnetic coupling with another of the gradient windings.
